(19) United States
(12) Patent Application Publication
(10) Pub. No.: US 2005/0271099 A1
(43) Pub. Date: Dec. 8, 2005

(54) BURST MODE TRANSMITTER SYSTEM

(75) Inventor: Reza Miremadi, West Hills, CA (US)

Correspondence Address: BARLOW, JOSEPHS & HOLMES, LTD., 101 DYER STREET, 5TH FLOOR, PROVIDENCE, RI, 02903, US

(73) Assignee: OPTICAL COMMUNICATION PRODUCTS, INC., Woodland Hills, CA (US)

(21) Appl. No.: 10/908,382

(22) Filed: May 10, 2005

Related U.S. Application Data
(60) Provisional application No. 60/576,929, filed on Jun. 4, 2004.

(51) Int. Cl. H01S 3/00

(52) U.S. Cl. 372/38.02

(57) ABSTRACT

An electrical circuit for a transmitter driver system that operates in burst or continuous mode includes a transmitter that generates an output signal in accordance with an input current. Modulation circuitry electrically connected to the transmitter, modulates the input current in accordance with the data signal input into the transmitter driver system. Power control circuitry electrically connected to the modulation circuitry and the transmitter generates a bias current to bias the input current and keep the average output signal of the transmitter substantially constant. An artificial modulation signal is generated with reference to the bias current and switched into the power control circuitry to emulate a continuous transmission mode.

### CROSS-REFERENCE TO RELATED APPLICATION

This Application claims priority to earlier filed U.S. Provisional Patent Application Ser. No. 60/576,929 filed Jun. 4, 2004, the contents of which are incorporated herein by reference.

### BACKGROUND OF THE INVENTION

1. Field of the Invention

The present invention relates to electronically controlled transmission systems and more particularly to optoelectronic transmitter devices for transmitting signals in such transmission systems.

2. Background of the Related Art

A typical optoelectronic laser transmitter system, as shown in FIG. 1 generally at 10, is comprised of modulation circuitry 12 and automatic power control (“APC”) circuitry 14. The modulation circuitry 12 converts the electrical data stream to current modulation that feeds a transmitter 16, such as a laser. The APC circuitry (or loop) 14 maintains the laser 16 output optical power constant with respect to temperature and other external variations.

The input data 18 modulates the current generator 20 which drives the laser 16. A bias current 17 generated by the APC loop 14 is applied to the laser 16 through current generator 22. The APC loop 14 monitors the output of an optical detector 24, such as a photodiode. This photodiode 24 is typically placed inside the laser 16 and is optically coupled to the laser 16. The difference between the output of the optical detector and the bias set point 26 is integrated by a resistor 28, capacitor 30 and amplifier 32. The APC loop 14 is completed by driving the current generator 22. The APC loop 14, therefore, keeps the average optical output power constant.

Normal optoelectronic laser driver systems such as the system 10 as shown in FIG. 1 are designed to drive the laser 16 continuously with a balanced (i.e. equal number of 1's and 0's) modulation current. The APC loop 14 is also designed for continuous output power control. However, not all transmission systems transmit data continuously. One type of non-continuous operation is known as “burst-mode” transmission. In “burst-mode” transmission, the system remains in an idle state, i.e. ready to transmit, and then, when required, operates to transmit a burst of data.

In burst mode applications, both the balanced modulation and continuous output power control requirements are no longer valid because the system 10 is required to intermittently transmit a burst of data rather than operate continuously. Accordingly, burst-mode transmission systems require different modulation and power control circuitry that will enable the transmitter to transmit a burst of data.

In the optoelectronics field, it has generally been considered that the conventional APC loop 14 of the prior art is unsuitable to keep the continuous power output of the laser 16 substantially constant between burst mode transmissions. In a typical transmitter circuit, the average power to the laser 16 would increase during this interval of zeroes (i.e. no data is present for transmission). This is a result of the APC loop 14 attempting to keep the output power constant. When the APC loop 14 detects a number of zeroes (no output power) it will try to increase the bias current to the laser 16 to increase the power. Failure to apply continuous power control to a transmitter circuit could result in the transmitter sending signals out of tolerance, thus resulting in a loss of data. Therefore, there is a need for a transmitter circuit that will maintain the power output to the transmitter substantially constant and within acceptable transmission tolerances.

### SUMMARY OF THE INVENTION

The present invention provides a novel burst mode transmitter system particularly adapted for use in a telecommunications system. The burst mode transmitter is adapted from a conventional continuous mode transmitter. Generally, the burst mode transmitter includes a laser that generates an output signal in accordance with an input current. Modulation circuitry electrically connected to the laser, modulates the input current in accordance with the data signal input into the laser driver system. Power control circuitry electrically connected to the modulation circuitry and the laser, and generates a bias current to bias the input current and keep the average output signal of the laser substantially constant. For operation in burst mode, an artificial modulation signal is generated with reference to the bias current and switched into the power control circuitry to emulate a continuous transmission mode.

Accordingly, an object of the present invention is to provide a circuit to allow a continuous mode laser transmitting system to operate in burst mode. Another object of the present invention is to provide a dummy driver circuit for a laser transmitter system that uses the bias current of the APC loop to generate a dummy monitoring signal to force the APC loop to behave as if the transmitter is operating in continuous mode during an absence of transmittable data.

Yet, another object of the present invention is to provide a circuit to maintain continuous power control to a laser transmitter system to keep the transmitter operating within acceptable transmission tolerances.

Yet, another object of the present invention is to provide continuous power control to a laser transmitter system when the data on the transmitting system is idle.

Yet, another object of the present invention is to provide a dummy driver system for a laser transmitter system that has a lookup table of temperature versus bias current values to be utilized to generate the dummy monitoring signal.

Other features and aspects of the present invention will become better understood with reference to the following description, drawings and appended claims.

### DESCRIPTION OF THE DRAWINGS

In the drawings which illustrate the best modes presently contemplated for carrying out the present invention:

FIG. 1 is a schematic view of a typical laser driver;

FIG. 2A is a schematic view of a laser driver modified in accordance with the present invention; and

FIG. 2B is a schematic view of the laser drive of FIG. 2A in with the switched in the idle position.

### DESCRIPTION OF THE PREFERRED EMBODIMENT

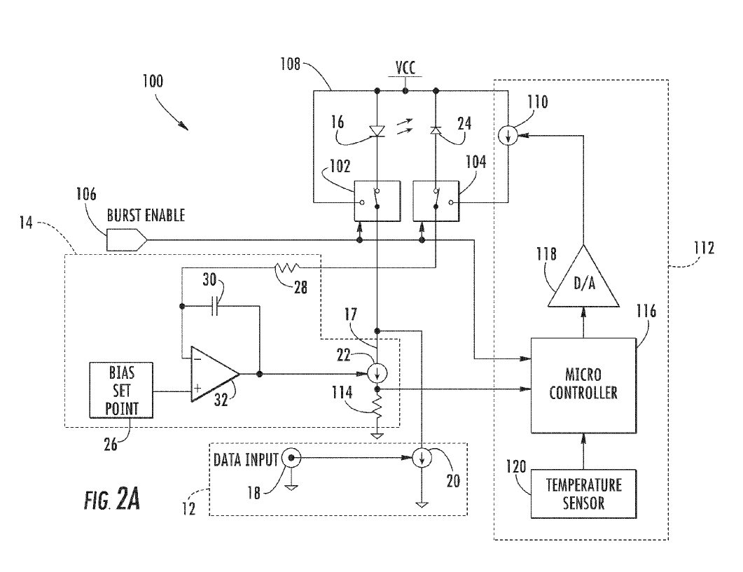

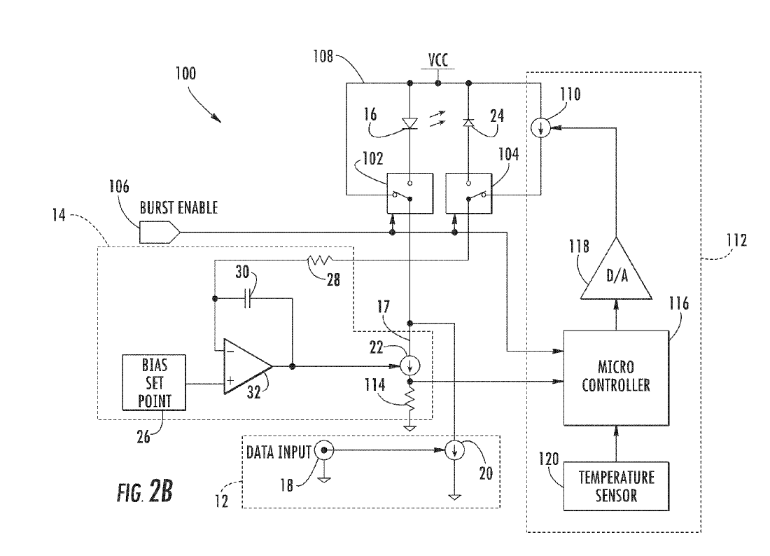

The present invention identifies that one way to make an existing transmitter driver system, such as a laser driver system, work as a burst transmitter is to trick the transmitter driver system into behaving as if it is always working in a continuous transmission mode. This is accomplished by switching a dummy driver into the circuit when there is no transmission so that the APC loop continues to function normally. This modified transmitter driver system is shown in FIG. 2A generally at 100. Although, the present invention is contemplated for optical transmitters using semiconductor lasers, this circuit could be used for any electrically controlled transmitting system whether it utilizes signals generated out of audio, visible light, or electrical means and is not limited to same. Therefore, the use of “laser” or “semiconductor laser” is referred to for ease of description but could be any transmitting device used to convert an electrical signal into another transmission signal, typically in the electromagnetic spectrum, and communicate that signal over any distance. Similarly, the use of “optical detector” or “photodiode” is referred to for ease of description but could also be any detecting device used to detect a signal and convert it to an electrical signal.

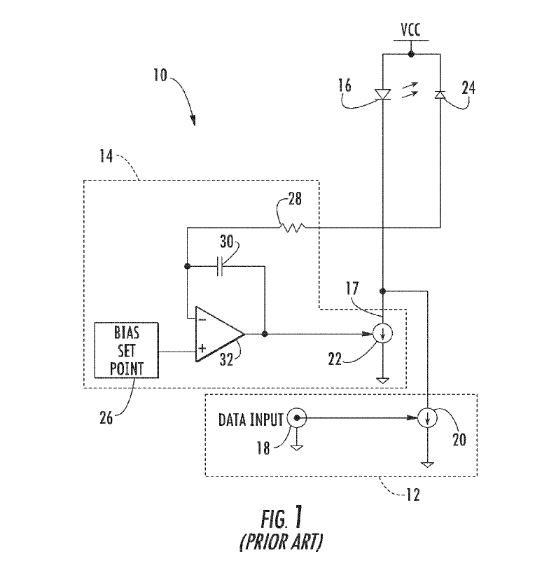

A typical optoelectronic laser transmitter system, as shown in FIG. 1 generally at 10, is comprised of modulation circuitry 12 and automatic power control (“APC”) circuitry 14. The modulation circuitry 12 converts the electrical data stream to current modulation that feeds a transmitter 16, such as a laser. The APC circuitry (or loop) 14 maintains the laser 16 output optical power constant with respect to temperature and other external variations.

The input data 18 modulates the current generator 20 which drives the laser 16. A bias current 17 generated by the APC loop 14 is applied to the laser 16 through current generator 22. The APC loop 14 monitors the output of an optical detector 24, such as a photodiode. This photodiode 24 is typically placed inside the laser 16 and is optically coupled to the laser 16. The difference between the output of the optical detector and the bias set point 26 is integrated by a resistor 28, capacitor 30 and amplifier 32. The APC loop 14 is completed by driving the current generator 22. The APC loop 14, therefore, keeps the average optical output power constant. A first switch 102 is connected between the APC loop 14 and the laser 16 and is settable between a first transmitter setting for operating the laser 16 and a second transmitter setting for bypassing the laser 16. Similarly, a second switch 104 is connected between the APC loop 14 and the optical detector 24 and is settable between a first detector setting for operating the optical detector 24 and a second detector setting for bypassing the optical detector. Each switch 102, 104 is controlled by an input signal 106 having a burst mode and an idle mode. The input signal 106 toggles the switches 102, 104 according to whether input data 18 is present for transmission or not. In burst mode, data 18 is present for transmission. In idle mode, no data 18 is present for transmission. With the switches 102, 104 set as shown in FIG. 2A, the system 100 works like a regular laser driver system 10 as depicted in FIG. 1 and described above. In this respect, the input signal 106 is selectively set by the input data 18 of the transmitter driver system 100.

A transmitter bypass circuit 108 containing a current source 110 for generating the artificial modulation signal is connected to the respective second transmitter setting and second detector setting of the switches 102, 104. When the input signal 106 is set to idle mode as shown in FIG. 2B, the transmitter bypass circuit 108 is switched into the circuit 100 in place of the laser 16 and the optical detector 24.

Selectively modulating the current source 110 of the transmitter bypass circuitry 108 is the dummy modulation circuitry 112. The dummy modulation circuitry 112 modulates the current source 110 according to the mode of the input signal 106.

When the input signal 106 is set to burst mode, i.e. data 18 is present for transmission; a dummy modulation circuitry 112 measures the laser bias current 17 across a resistor 114 and stores its value, but does not modulate the current source 110 of the transmitter bypass circuitry 108. There are numerous ways to measure and store the bias current 17 for later use that are well-known in the art.

When the input signal 106 is set to idle mode, i.e. data 18 is not present for transmission; the dummy modulation circuitry 112 modulates the current source 110 to maintain the laser bias current 17 at the stored value. In this configuration, the laser driver system 100 continues to operate normally because the current flows through the bypass circuitry 108 as normal and an artificial monitoring current is generated by current source 110.

Preferably, the dummy modulation circuitry 112 comprises a microcontroller 116 that modulates the current source 110 through a digital to analog (“D/A”) converter 118. Other configurations are possible, however.

If the laser driver system 100 is to be operated with a long duration between bursts, then a temperature sensor 120 can be used to store a lookup table of bias current values versus temperature values. Building a lookup table and subsequently accessing the data contained therein is well known in the art and will not be discussed here. The temperature sensor 120 is connected to the microcontroller 112. The microcontroller 112 will store the temperature and bias current measurements into the lookup table. In idle mode, the microcontroller 112 will consult the lookup table with reference to the current temperature measurement to retrieve the stored bias value to use to generate the modulation signal. This look up table can be slowly modified by actual readings of the bias over temperature. In this way, as the laser ages, the look up table will continue to be accurate.

Therefore, a new and unique circuit for converting a continuous mode transmitter circuit for burst mode applications is provided. The dummy driver circuitry 112 measures the bias current 17 during periods of transmitting activity in order to later generate a dummy monitoring signal to feed the APC loop 14 during periods of idle transmission activity. Furthermore, the use of a temperature sensor 120 and associated lookup table enables the dummy driver circuit 112 to generate an appropriate dummy monitoring signal during prolonged periods of inactivity.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as limited by the appended claims.

1. An electrical circuit for a transmitter driver system having a data signal, comprising:
a transmitter configured and arranged to receive an input current, the transmitter generating an output signal in accordance with the input current;
modulation circuitry electrically connected to the transmitter, the modulation circuitry generating the input current and modulating the input current in accordance with the data signal;
power control circuitry electrically connected to the modulation circuitry and the transmitter, the power control circuitry generating a bias current to bias the input current to keep the average output signal of the transmitter substantially constant;
means for generating an artificial modulation signal with reference to the bias current; and
means for selectively switching the artificial modulation signal into the power control circuitry to emulate a continuous transmission mode.

2. The circuit of claim 1, wherein the means for generating comprises:
a microcontroller connected to the bias current, the microcontroller generating an artificial modulation signal in a digital format with reference to the bias current; and
a digital analog converter connected to the microcontroller, the digital analog converter being configure and arranged to convert the artificial modulation signal into an analog format.

3. The circuit of claim 1, wherein the transmitter is an optical device.

4. The circuit of claim 1, wherein the transmitter is a semiconductor laser.

5. The circuit of claim 1, further comprising:
a temperature sensor for measuring the temperature of the transmitter over a predetermined interval,
wherein said means for generating an artificial modulation signal further references the measurements of the temperature sensor.

6. The circuit of claim 5, further comprising:
a lookup table for storing the temperature measured by the temperature sensor versus the bias current of the power control circuitry,
wherein said means for generating the artificial modulation signal references the lookup table in order to generate the artificial modulation signal.

7. A circuit for controlling an optical transmitter comprising:
an optical transmitter configured and arranged to receive an input signal, the optical transmitter generating an optical signal in accordance with the input signal;
an optical detector optically coupled to the optical signal of the optical transmitter, the optical detector generating a monitoring signal in accordance with the optical signal;
an automatic power control circuit electrically coupled to the monitoring signal of the optical detector, the automatic power control circuit generating a bias signal with reference to the monitoring signal and a bias set point;
a modulation circuit electrically coupled to the input signal, a data signal and the bias signal, the modulation circuit generating the input signal and modulating the input signal with reference to the data signal and the bias signal;
means for generating an artificial monitoring signal with reference to the bias signal;
means for selectively switching the artificial monitoring signal into the automatic power control circuit in place of the monitoring signal in order to emulate a continuous transmission mode.

8. The circuit of claim 7, wherein the means for generating comprises:
a temperature sensor for detecting the temperature of the laser;
a dummy modulating circuit for generating an artificial monitoring signal, the dummy modulating circuit having a lookup table with the stored values of the bias current versus the temperature of the laser over a predetermined period of time.

9. The circuit of claim 7, wherein the means for generating comprises:
a microcontroller electrically connected to the bias signal, the microcontroller generating an artificial monitoring signal in digital format; and
a digital analog converter connected to the microcontroller, the digital analog converter converting the artificial monitoring signal into analog format.

10. The circuit of claim 7, wherein the optical transmitter is a laser.

11. A circuit for controlling an optical transmitter comprising:
a laser configured and arranged to receive an input signal, said laser converting said input signal into an optical signal;
an optical detector optically coupled to the optical signal of the laser, said optical detector converting said optical signal into a monitoring signal;
an automatic power control circuit configured and arranged to receive said monitoring signal of said optical detector, said automatic power control circuit generating a bias signal with reference to said monitoring signal and a bias set point;
a modulation circuit electrically coupled to the input signal, a data signal and the bias signal, the modulation circuit modulating the input signal with reference to the data signal and the bias signal;
a temperature sensor for detecting the temperature of the laser;
a dummy modulating circuit for generating an artificial monitoring signal, the dummy modulating circuit having a lookup table with the stored values of the bias current versus the temperature of the laser over a predetermined interval; and
means for switching the artificial monitoring signal into the automatic power control circuit in place of the monitoring signal in order to emulate a continuous transmission mode.

12. The circuit of claim 11, wherein the dummy modulating circuit further comprises:
a microcontroller electrically connected to the bias signal, the microcontroller generating an artificial monitoring signal in digital format; and
a digital analog converter connected to the microcontroller, the digital analog converter converting the artificial monitoring signal into analog format.

13. The circuit of claim 11, wherein the optical transmitter is a semiconductor laser.
